(19) United States
(12) Patent Application Publication
(10) Pub. No.: US 2024/0381231 A1
(43) Pub. Date: Nov. 14, 2024

(54) NETWORK NODES AND METHODS THEREIN FOR FACILITATING NETWORK FUNCTION DISCOVERY

(71) Applicant: TELEFONAKTIEBOLAGET LM ERICSSON (PUBL), Stockholm (SE)

(72) Inventors: CHENGCHUN ZHUO, SHANGHAI (CN); YUNJIE LU, SHANGHAI (CN)

(21) Appl. No.: 18/293,021

(22) PCT Filed: Jul. 28, 2022
(86) PCT No.: PCT/CN2022/108556

§ 371 Date: Jan. 29, 2024

(30) Foreign Application Priority Data
Jul. 30, 2021 (WO) PCT/CN2021/109869

(51) Int. Cl. H04W 48/16; H04W 8/18; H04W 24/04; H04W 48/18

(52) U.S. Cl. CPC H04W 48/16; H04W 8/18; H04W 24/04; H04W 48/18

(57) ABSTRACT

The present disclosure provides a method (200) in a first Network Function, NF. The method (200) includes: transmitting (210), to a second NF, a subscription request for subscribing to a notification from the second NF. The subscription request contains: a Uniform Resource Identifier, URI, of an NF Repository Function, NRF, to be used to discover an alternative NF for the notification, or information on a network slice to which the first NF belongs.

### CROSS-REFERENCE TO RELATED APPLICATION(S)

This application claims priority to the PCT International Application No. PCT/CN2021/109869, entitled “NETWORK NODES AND METHODS THEREIN FOR FACILITATING NETWORK FUNCTION DISCOVERY”, filed on Jul. 30, 2021, which is incorporated herein by reference in its entirety.

### TECHNICAL FIELD

The present disclosure relates to communication technology, and more particularly, to network nodes and methods therein for facilitating Network Function (NF) discovery.

### BACKGROUND

In the 5^{th} Generation (5G) system, an NF, such as Session Management Function (SMF), Policy Control function (PCF), Network Exposure Function (NEF), Short Message Service Function (SMSF), and Unified Data Management (UDM) can subscribe to an Access and Mobility Management Function (AMF) status change event via an AmfStatusChangeSubscribe operation, and the NF can provide an callback Uniform Resource Identifier (URI) to receive the notification, according to the 3^{rd} Generation Partnership Project (3GPP) Technical Specification (TS) 29.518, V17.2.0, which is incorporated herein by reference in its entirety. In particular, Table 6.1.6.2.2-1 in TS 29.518, which is reproduced as Table 1 below, gives a definition of type SubscriptionData:

TABLE 1
Definition of type SubscriptionData

| Attribute name | Data type | P | Cardinality | Description |
|---|---|---|---|---|
| amfStatusUri | Uri | M | 1 | This IE (Information Element) shall include the |
| | | | | callback URI to receive notification of AMF status |
| | | | | change. |
| guamiList | array(Guami) | C | 1 . . . N | This IE shall be absent for subscribing to status |
| | | | | change for any GUAMI (Globally Unique AMF |
| | | | | Identifier) supported by the AMF, it shall be present |
| | | | | for subscribing to specific GUAMIs supported by the |
| | | | | AMF. |

According to the 3GPP TS 29.500, V17.3.0, which is incorporated herein by reference in its entirety, the NF can provide a binding indication, indicating that the AMF can send the notification to an alternative endpoint within binding resources, e.g., when the NF is no longer available or reachable.

FIG. 1 shows an exemplary procedure of AMF status change notification. As shown, at 1.1, an NF sends a subscription request (Namf_Communication_AMFStatusChangeSubscribe Request) to an AMF. The request contains a callback URI (amfStatusUri) and a binding indication indicating a binding level bl=nf-set and a NF Set ID nfset=set1.xxxset.5gc.mnc012.mcc300. At 1.2, the AMF responds with a subscription response (Namf_Communication_AMFStatusChangeSubscribe Response). At 1.3, the AMF detects a failure of the NF or a failure in delivery of a notification to the NF (e.g., no response is received from the NF for a predetermined time length, or the NF is not available or reachable). In this case, the AMF needs to discover an alternative NF to receive the notification based on the binding indication. In particular, at 1.4, the AMF sends a discovery request (Nnrf_NFDiscover Request) to an NF Repository Function (NRF), with a target NF Set ID set to set1.xxxset.5gc.mnc012.mcc30. At 1.5, the NRF responds with one or more NF profiles of one or more NF instances in the target NF Set. Then, the AMF can select, from the one or more NF instances, an alternative NF and send the notification to the alternative NF.

However, some NFs may be network slice specific or may be shared between network slices, depending on network deployment. For example, in a network deployment with three network slices, Slice #1, Slice #2, and Slice #3, an AMF may be shared between all three network slices, while an NRF, NRF #1, is dedicated to Slice #1 and another NRF, NRF #2, is shared between Slice #2 and Slice #3. In this case, in the above step 1.4 in FIG. 1, the AMF may not know which of the NRFs (NRF #1 and NRF #2) is to be used for the NF discovery, as it may not know which NRF the NF belongs to.

### SUMMARY

It is an object of the present disclosure to provide network nodes and methods therein, capable of solving the above problem.

According to a first aspect of the present disclosure, a method in a first NF is provided. The method includes: transmitting, to a second NF, a subscription request for subscribing to a notification from the second NF. The subscription request contains: a URI of an NRF, to be used to discover an alternative NF for the notification, or information on a network slice to which the first NF belongs.

In an embodiment, the URI or the information may be contained in a message body of the subscription request.

In an embodiment, the URI or the information may be contained in a HyperText Transfer Protocol (HTTP) custom header in the subscription request.

In an embodiment, the URI may be an NRF Application Programming Interface (API) URI for an NF discovery service, or the information may be Single Network Slice Selection Assistance Information (S-NSSAI).

In an embodiment, the subscription request may further contain a binding indication for reselection of the alternative NF.

In an embodiment, each of the first NF and the alternative NF may be an NF consumer and the second NF may be an NF producer.

In an embodiment, the second NF may be an AMF.

According to a second aspect of the present disclosure, a method in a second NF is provided. The method includes: receiving, from a first NF, a subscription request for subscribing to a notification from the second NF. The subscription request contains a URI of an NRF to be used to discover an alternative NF for the notification.

In an embodiment, the URI may be contained in a message body of the subscription request or in an HTTP custom header in the subscription request.

In an embodiment, the method may further include: transmitting an NF discovery request for discovering the alternative NF to the NRF using the URI; receiving, from the NRF, an NF profile of the alternative NF; and transmitting the notification to the alternative NF.

In an embodiment, the NF discovery request may be transmitted in response to detecting a failure of the first NF or a failure in delivery of the notification to the first NF.

In an embodiment, the subscription request may further contain a binding indication for reselection of the alternative NF, and the NF discovery request may be for discovering the alternative NF based on the binding indication.

In an embodiment, the method may further include: transmitting the notification to a Service Communication Proxy (SCP) between the first NF and the second NF, the notification containing the URI.

In an embodiment, the URI may be contained in an HTTP custom header in the notification.

In an embodiment, the subscription request may further contain a binding indication for reselection of the alternative NF, and the notification may further contain the binding indication.

In an embodiment, the URI may be an NRF API URI for an NF discovery service.

In an embodiment, each of the first NF and the alternative NF may be an NF consumer and the second NF may be an NF producer.

In an embodiment, the second NF may be an AMF.

According to a third aspect of the present disclosure, a method in a second NF is provided. The method includes: receiving, from a first NF, a subscription request for subscribing to a notification from the second NF. The subscription request contains information on a network slice to which the first NF belongs.

In an embodiment, the information may be contained in a message body of the subscription request or in an HTTP custom header in the subscription request.

In an embodiment, the method may further include: obtaining, from a Network Slice Selection Function (NSSF), a URI of an NRF associated with the network slice using the information.

In an embodiment, the method may further include: transmitting an NF discovery request for discovering an alternative NF for the notification to the NRF using the URI; receiving, from the NRF, an NF profile of the alternative NF; and transmitting the notification to the alternative NF.

In an embodiment, the URI may be obtained and/or the NF discovery request may be transmitted in response to detecting a failure of the first NF or a failure in delivery of the notification to the first NF.

In an embodiment, the subscription request may further contain a binding indication for reselection of the alternative NF, and the NF discovery request may be for discovering the alternative NF based on the binding indication.

In an embodiment, the method may further include: transmitting the notification to an SCP between the first NF and the second NF, the notification containing the URI.

In an embodiment, the URI may be contained in an HTTP custom header in the notification.

In an embodiment, the URI may be an NRF API URI for an NF discovery service.

In an embodiment, the method may further include: transmitting the notification to an SCP between the first NF and the second NF, the notification containing the information.

In an embodiment, the subscription request may further contain a binding indication for reselection of the alternative NF, and the notification may further contain the binding indication.

In an embodiment, the information may be S-NSSAI.

In an embodiment, each of the first NF and the alternative NF may be an NF consumer and the second NF may be an NF producer.

In an embodiment, the second NF may be an AMF.

According to a fourth aspect of the present disclosure, a method in an SCP between a first NF and a second NF is provided. The method includes: receiving, from the second NF, a notification to be forwarded to the first NF, the notification containing information on a network slice to which the first NF belongs; obtaining, from an NSSF, a URI of an NRF associated with the network slice using the information; transmitting an NF discovery request for discovering an alternative NF for the notification to the NRF using the URI; receiving, from the NRF, an NF profile of the alternative NF; and transmitting the notification to the alternative NF.

In an embodiment, the URI may be obtained and/or the NF discovery request may be transmitted in response to detecting a failure in delivery of the notification to the first NF.

In an embodiment, the notification may further contain a binding indication for reselection of the alternative NF, and the NF discovery request may be for discovering the alternative NF based on the binding indication.

In an embodiment, the information may be S-NSSAI, and/or the URI may be an NRF API URI for an NF discovery service.

In an embodiment, each of the first NF and the alternative NF may be an NF consumer and the second NF may be an NF producer.

In an embodiment, the second NF may be an AMF.

According to a fifth aspect of the present disclosure, a network node is provided. The network node includes a communication interface, a processor and a memory. The memory contains instructions executable by the processor whereby the network node is operative to, when implementing a first NF, perform the method according to the above first aspect, or when implementing a second NF, perform the method according to the above second or third aspect, or when implementing an SCP, perform the method according to the above fourth aspect.

According to a sixth aspect of the present disclosure, a computer-readable storage medium is provided. The computer-readable storage medium has computer-readable instructions stored thereon. The computer-readable instructions, when executed by a processor of a network node, configure the network node to, when implementing a first NF, perform the method according to the above first aspect, or when implementing a second NF, perform the method according to the above second or third aspect, or when implementing an SCP, perform the method according to the above fourth aspect.

With the embodiments of the present disclosure, a first NF can transmit, to a second NF, a subscription request for subscribing to a notification from the second NF. The subscription request can contain: a URI of an NRF to be used to discover an alternative NF for the notification, or information on a network slice to which the first NF belongs. In this way, a proper NRF to be used to discover the alternative NF can be found, e.g., for NF reselection when the first NF is no longer available or reachable.

### BRIEF DESCRIPTION OF THE DRAWINGS

The above and other objects, features and advantages will be more apparent from the following description of embodiments with reference to the figures, in which:

FIG. 1 is a sequence diagram showing an exemplary procedure of AMF status change notification;

FIG. 2 is a flowchart illustrating a method in a first NF according to an embodiment of the present disclosure;

FIG. 3 is a flowchart illustrating a method in a second NF according to an embodiment of the present disclosure;

FIG. 4 is a flowchart illustrating a method in a second NF according to another embodiment of the present disclosure;

FIG. 5 is a flowchart illustrating a method in an SCP according to an embodiment of the present disclosure;

FIG. 6 is a sequence diagram showing an exemplary procedure of AMF status change notification according to an embodiment of the present disclosure;

FIG. 7 is a sequence diagram showing an exemplary procedure of AMF status change notification according to another embodiment of the present disclosure;

FIG. 8 is a sequence diagram showing an exemplary procedure of AMF status change notification according to yet another embodiment of the present disclosure;

FIG. 9 is a sequence diagram showing an exemplary procedure of AMF status change notification according to still another embodiment of the present disclosure;

FIG. 10 is a sequence diagram showing an exemplary procedure of AMF status change notification according to still yet another embodiment of the present disclosure;

FIG. 11 is a block diagram of a network node according to an embodiment of the present disclosure;

FIG. 12 is a block diagram of a network node according to another embodiment of the present disclosure;

FIG. 13 is a block diagram of a network node according to yet another embodiment of the present disclosure; and

FIG. 14 is a block diagram of a network node according to still another embodiment of the present disclosure.

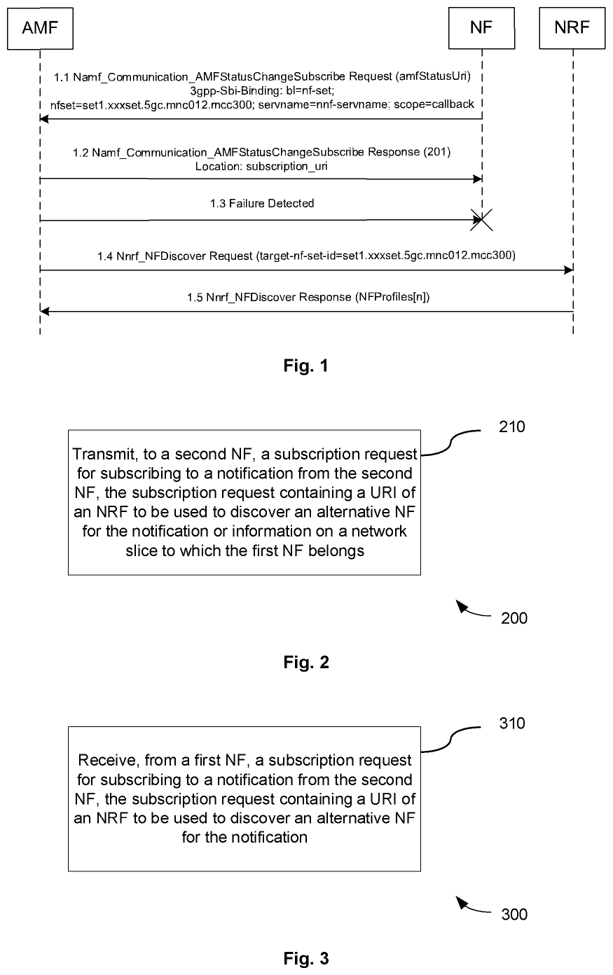

### DETAILED DESCRIPTION

In the present disclosure, a network function, or NF, can be implemented either as a network element on a dedicated hardware, as a software instance running on a dedicated hardware, or as a virtualized function instantiated on an appropriate platform, e.g. on a cloud infrastructure.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In the following description and claims, unless defined otherwise, all technical and scientific terms used herein have the same meaning as commonly understood by one of ordinary skills in the art to which this disclosure belongs.

FIG. 2 is a flowchart illustrating a method 200 according to an embodiment of the present disclosure. The method 200 can be performed at a first NF, e.g., an NF consumer.

At block 210, the first NF transmits, to a second NF, a subscription request for subscribing to a notification from the second NF. The subscription request contains a URI of an NRF to be used to discover an alternative NF for the notification. Alternatively or additionally, the subscription request contains information on a network slice to which the first NF belongs (referred to as “slice information” hereinafter).

Here, the second NF may be an NF producer, e.g., an AMF. The alternative NF may be an NF consumer, which is assumed to belong to the same network slice as the first NF.

In an example, the URI may be an NRF API URI for an NF discovery service. The slice information may be Single Network Slice Selection Assistance Information, S-NSSAI.

In an example, the URI or the slice information may be contained in a message body (e.g., Java Script Object Notation (JSON) body) of the subscription request. For example, the URI may be included in the type SubscriptionData. In this case, the definition of the type SubscriptionData in Table 1 can be extended to include an attribute “nrfDiscUri”, as shown in Table 2 below:

TABLE 2
Definition of type SubscriptionData

| Attribute name | Data type | P | Cardinality | Description |
|---|---|---|---|---|
| amfStatusUri | Uri | M | 1 | This IE shall include the callback URI to receive |
| | | | | notification of AMF status change. |
| guamiList | array(Guami) | C | 1 . . . N | This IE shall be absent for subscribing to status |
| | | | | change for any GUAMI supported by the AMF, it shall |
| | | | | be present for subscribing to specific GUAMIs |
| | | | | supported by the AMF. |
| nrfDiscUri | URI | C | 0 . . . 1 | The URI of NRF Discover service to be used when |
| | | | | AMF needs to discover alternatives of the subscribing |
| | | | | NF service instance. |

In another example, the URI or the slice information may be contained in an HTTP custom header in the subscription request. For example, a new HTTP custom header, “3gpp-Sbi-Nrf-Uri-Callback”, can be introduced. In particular, Table 5.2.3.2.1-1 in TS 29.500 can be extended to include the 3gpp-Sbi-Nrf-Uri-Callback header, as shown in Table 3 below:

TABLE 3
Mandatory HTTP custom header

| Name | Reference | Description |
|---|---|---|
| 3gpp-Sbi-Nrf-Uri-Callback | Clause 5.2.3.2.x | This header may be used to indicate the NRF API URI to |
| | | be used to discover an alternative NF consumer for |
| | | callback, e.g. during NF consumer reselection for |
| | | callback when the original NF consumer is no longer |
| | | available. |

In addition, the subscription request may further contain a binding indication for reselection of the alternative NF. In an example, the slice information may be contained in a 3gpp-Sbi-Binding header or a newly defined header.

FIG. 3 is a flowchart illustrating a method 300 according to an embodiment of the present disclosure. The method 300 can be performed at a second NF, e.g., an NF producer (which may be an AMF for example).

At block 310, the second NF receives, from a first NF, a subscription request for subscribing to a notification from the second NF. The subscription request contains a URI of an NRF to be used to discover an alternative NF for the notification.

Here, each of the first NF and the alternative NF may be an NF consumer.

In an example, the URI may be an NRF API URI for an NF discovery service. The URI may be contained in a message body of the subscription request (e.g., referring to the above Table 2) or in an HTTP custom header in the subscription request (e.g., “3gpp-Sbi-Nrf-Uri-Callback” header, referring to the above Table 3).

In an example, e.g., in response to detecting a failure of the first NF or a failure in delivery of the notification to the first NF (e.g., when no response is received from the first NF for a predetermined time length, or the NF is not available or reachable), the second NF can transmit an NF discovery request for discovering the alternative NF to the NRF using the URI, then receive, from the NRF, an NF profile of the alternative NF, and transmit the notification to the alternative NF. Here, the subscription request received in the block 310 may further contain a binding indication for reselection of the alternative NF, and the NF discovery request may be used for discovering the alternative NF based on the binding indication.

In another example, in a case of indirection communication between the first NF and the second NF (i.e., via an SCP), the second NF may transmit the notification to the SCP between the first NF and the second NF. The notification may contain the URI of the NRF. Here, the URI may be contained in an HTTP custom header (e.g., 3gpp-Sbi-Nrf-Uri header defined in Table 5.2.3.2.1-1 in TS 29.500) in the notification. Moreover, the subscription request received in the block 310 may further contain a binding indication for reselection of the alternative NF, and the notification may further contain the binding indication.

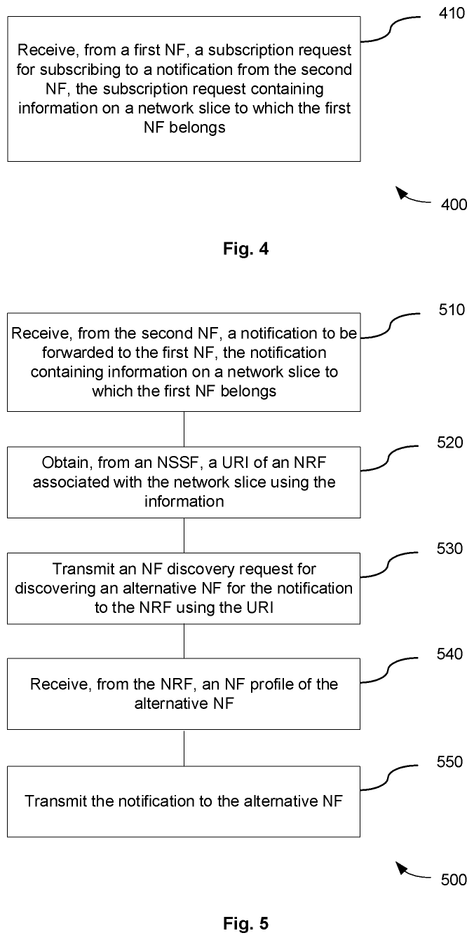

FIG. 4 is a flowchart illustrating a method 400 according to an embodiment of the present disclosure. The method 400 can be performed at a second NF, e.g., an NF producer (which may be an AMF for example).

At block 410, the second NF receives, from a first NF, a subscription request for subscribing to a notification from the second NF. The subscription request contains information on a network slice to which the first NF belongs (referred to as “slice information” hereinafter).

Here, each of the first NF and the alternative NF may be an NF consumer.

In an example, the slice information may be S-NSSAI. The slice information may be contained in a message body (e.g., JSON body, or SubscriptionData) of the subscription request or in an HTTP custom header (e.g., 3gpp-Sbi-Binding header or a newly defined header) in the subscription request.

In an example, the second NF may obtain, from an NSSF, a URI of an NRF associated with the network slice using the slice information (e.g., by using Nnssf_NSSelection_Get). Here, the URI may be an NRF API URI for an NF discovery service.

In an example, the second NF can transmit an NF discovery request for discovering the alternative NF to the NRF using the URI, then receive, from the NRF, an NF profile of the alternative NF, and transmit the notification to the alternative NF. Here, the subscription request received in the block 410 may further contain a binding indication for reselection of the alternative NF, and the NF discovery request may be used for discovering the alternative NF based on the binding indication.

Here, the URI may be obtained and/or the NF discovery request may be transmitted in response to detecting a failure of the first NF or a failure in delivery of the notification to the first NF (e.g., when no response is received from the first NF for a predetermined time length, or the NF is not available or reachable).

In another example, in a case of indirection communication between the first NF and the second NF (i.e., via an SCP), the second NF may transmit the notification to the SCP between the first NF and the second NF. The notification may contain the URI of the NRF. Here, the URI may be contained in an HTTP custom header (e.g., 3gpp-Sbi-Nrf-Uri header defined in Table 5.2.3.2.1-1 in TS 29.500) in the notification. Alternatively, the notification may contain the slice information.

Moreover, the subscription request received in the block 410 may further contain a binding indication for reselection of the alternative NF, and the notification may further contain the binding indication.

FIG. 5 is a flowchart illustrating a method 500 according to an embodiment of the present disclosure. The method 500 can be performed at an SCP between a first NF (e.g., an NF consumer) and a second NF (e.g., an NF producer, which may be an AMF for example).

At block 510, the SCP receives, from the second NF, a notification to be forwarded to the first NF. The notification contains information on a network slice to which the first NF belongs (referred to as “slice information” hereinafter). Here, the slice information may be S-NSSAI.

At block 520, the SCP obtains, from an NSSF, a URI of an NRF associated with the network slice using the slice information (e.g., by using Nnssf_NSSelection_Get). Here, the URI may be an NRF API URI for an NF discovery service.

At block 530, the SCP transmits, to the NRF by using the URI, an NF discovery request for discovering an alternative NF (e.g., an NF consumer) for the notification.

Here, the notification received in the block 510 may further contain a binding indication for reselection of the alternative NF, and the NF discovery request may be for discovering the alternative NF based on the binding indication.

In an example, the operation in the block 520 and/or the operation in the block 530 may be performed e.g., in response to detecting a failure of the first NF or a failure in delivery of the notification to the first NF (e.g., when no response is received from the first NF for a predetermined time length, or the NF is not available or reachable).

At block 540, the SCP receives, from the NRF, an NF profile of the alternative NF.

At block 550, the SCP transmits the notification to the alternative NF.

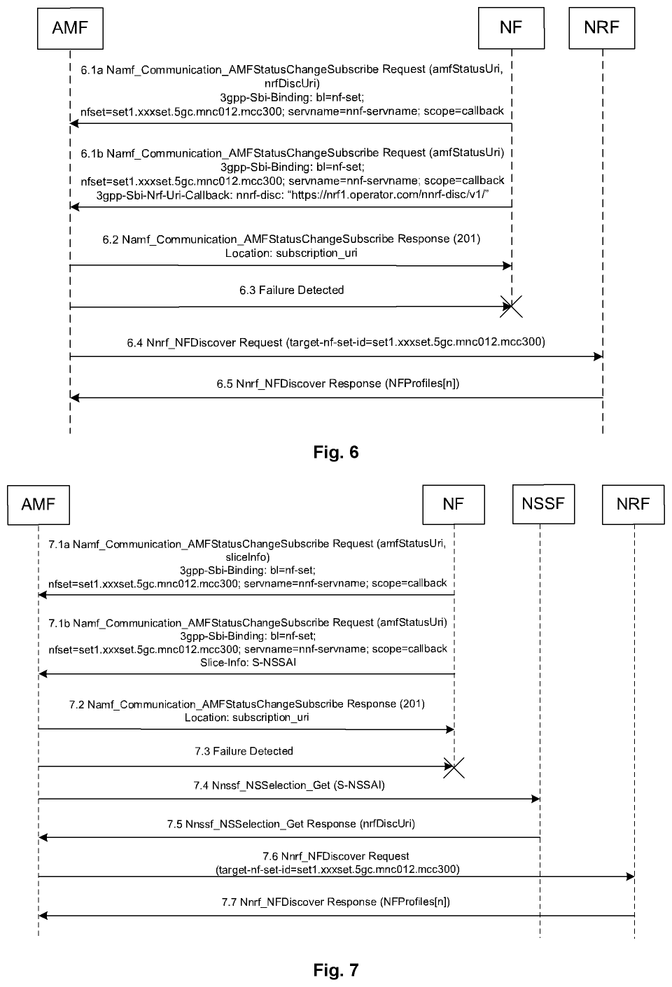

In the following, the above methods 200˜500 will be further explained with reference to exemplary procedures of AMF status change notification as shown in FIGS. 6-10. In these procedures, an NF (as an NF consumer) subscribes to an AMF status change notification from an AMF (as an NF producer). It is to be noted that the embodiments of the present disclosure are not limited to AMF status change notification, but are applicable to subscriptions to other AMF notifications, such as AMF event exposure service using AmfEventSubscription defined in Section 6.2.6.2.2 of TS 29.518, or more generally, to any notification from any NF producer.

FIG. 6 shows an exemplary procedure of AMF status change notification, with direct communication between the NF and the AMF. As shown, at 6.1a, the NF sends a subscription request (Namf_Communication_AMFStatusChangeSubscribe Request) to the AMF. The request contains a callback URI (amfStatusUri) and a binding indication (in 3gpp-Sbi-Binding) indicating a binding level bl=nf-set and a NF Set ID nfset=set1.xxxset.5gc.mnc012.mcc300. The request further contains, in its message body (e.g., nrfDiscUri), a URI of an NRF to be used to discover an alternative NF for the notification. Alternatively, at 6.1b, the NF sends a subscription request (Namf_Communication_AMFStatusChangeSubscribe Request) to the AMF. The request contains a callback URI (amfStatusUri) and a binding indication (in 3gpp-Sbi-Binding) indicating a binding level bl=nf-set and a NF Set ID nfset=set1.xxxset.5gc.mnc012.mcc300. The request further contains, in an HTTP custom header (e.g., 3gpp-Sbi-Nrf-Uri-Callback), a URI of an NRF to be used to discover an alternative NF for the notification, e.g., nnrf-disc: “https://nrf1.operator.com/nnrf-disc/v1/”.

At 6.2, the AMF responds with a subscription response (Namf_Communication_AMFStatusChangeSubscribe Response). At 6.3, the AMF detects a failure of the NF or a failure in delivery of a notification to the NF. At 6.4, the AMF sends a discovery request (Nnrf_NFDiscover Request) to the NRF using the URI, with a target NF Set ID set to set1.xxxset.5gc.mnc012.mcc30. At 6.5, the NRF responds with one or more NF profiles of one or more NF instances in the target NF Set. Then, the AMF can select, from the one or more NF instances, an alternative NF and send the notification to the alternative NF.

FIG. 7 shows an exemplary procedure of AMF status change notification, with direct communication between the NF and the AMF. As shown, at 7.1a, the NF sends a subscription request

(Namf_Communication_AMFStatusChangeSubscribe Request) to the AMF. The request contains a callback URI (amfStatusUri) and a binding indication (in 3gpp-Sbi-Binding) indicating a binding level bl=nf-set and a NF Set ID nfset=set1.xxxset.5gc.mnc012.mcc300. The request further contains, in its message body (e.g., sliceInfo), information on a network slice to which the first NF belongs (referred to as slice information hereinafter, e.g., S-NSSAI). Alternatively, at 7.1b, the NF sends a subscription request (Namf_Communication_AMFStatusChangeSubscribe Request) to the AMF. The request contains a callback URI (amfStatusUri) and a binding indication (in 3gpp-Sbi-Binding) indicating a binding level bl=nf-set and a NF Set ID nfset=set1.xxxset.5gc.mnc012.mcc300. The request further contains the slice information (e.g., S-NSSAI) in an HTTP custom header (e.g., Slice-Info).

At 7.2, the AMF responds with a subscription response (Namf_Communication_AMFStatusChangeSubscribe Response). At 7.3, the AMF detects a failure of the NF or a failure in delivery of a notification to the NF. At 7.4, the AMF sends, to an NSSF, a request (Nnssf_NSSelection_Get) for an URI of an NRF associated with the slice information. At 7.5, the NSSF responds with the URI (e.g., nrfDiscUri) in a Nnssf_NSSelection_Get Response. At 7.6, the AMF sends a discovery request (Nnrf_NFDiscover Request) to the NRF using the URI, with a target NF Set ID set to set1.xxxset.5gc.mnc012.mcc30. At 7.7, the NRF responds with one or more NF profiles of one or more NF instances in the target NF Set. Then, the AMF can select, from the one or more NF instances, an alternative NF and send the notification to the alternative NF. It is to be noted here that the step 7.4 may be performed before the failure is detected at 7.3, and the step 7.6 may be performed in response to detecting the failure.

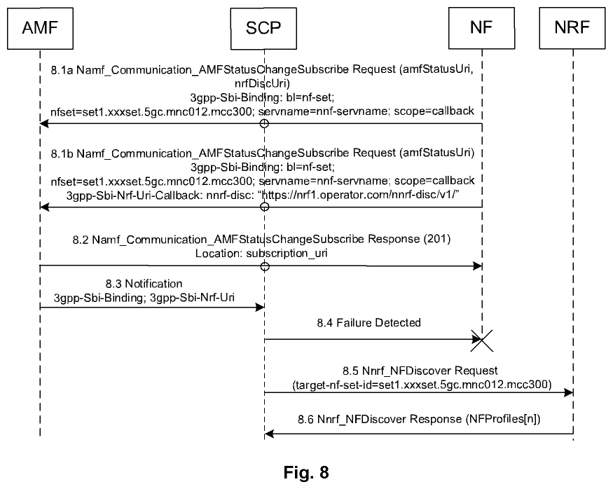

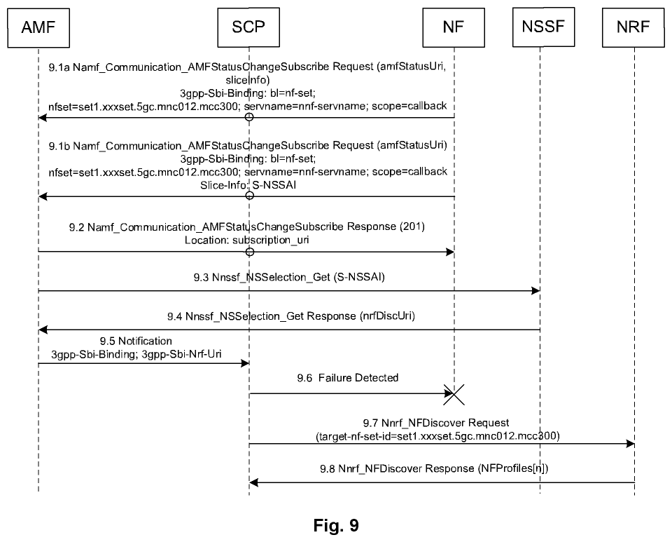

FIG. 8 shows an exemplary procedure of AMF status change notification, with indirect communication via an SCP between the NF and the AMF. As shown, at 8.1a, the NF sends, via the SCP, a subscription request (Namf_Communication_AMFStatusChangeSubscribe Request) to the AMF. The request contains a callback URI (amfStatusUri) and a binding indication (in 3gpp-Sbi-Binding) indicating a binding level bl=nf-set and a NF Set ID nfset=set1.xxxset.5gc.mnc012.mcc300. The request further contains, in its message body (e.g., nrfDiscUri), a URI of an NRF to be used to discover an alternative NF for the notification. Alternatively, at 8.1b, the NF sends, via the SCP, a subscription request (Namf_Communication_AMFStatusChangeSubscribe Request) to the AMF. The request contains a callback URI (amfStatusUri) and a binding indication (in 3gpp-Sbi-Binding) indicating a binding level bl=nf-set and a NF Set ID nfset=set1.xxxset.5gc.mnc012.mcc300. The request further contains, in an HTTP custom header (e.g., 3gpp-Sbi-Nrf-Uri-Callback), a URI of an NRF to be used to discover an alternative NF for the notification, e.g., nnrf-disc: “https://nrf1.operator.com/nnrf-disc/v1/”.

At 8.2, the AMF responds, via the SCP, with a subscription response (Namf_Communication_AMFStatusChangeSubscribe Response). At 8.3, the AMF sends a notification to the SCP. The notification contains the binding indication and the URI (e.g., in 3gpp-Sbi-Nrf-Uri). At 8.4, the SCP detects a failure of the NF or a failure in delivery of a notification to the NF. At 8.5, the SCP sends a discovery request (Nnrf_NFDiscover Request) to the NRF using the URI, with a target NF Set ID set to set1.xxxset.5gc.mnc012.mcc30. At 8.6, the NRF responds with one or more NF profiles of one or more NF instances in the target NF Set. Then, the SCP can select, from the one or more NF instances, an alternative NF and send the notification to the alternative NF.

FIG. 9 shows an exemplary procedure of AMF status change notification, with indirect communication via an SCP between the NF and the AMF. As shown, at 9.1a, the NF sends, via the SCP, a subscription request (Namf_Communication_AMFStatusChangeSubscribe Request) to the AMF. The request contains a callback URI (amfStatusUri) and a binding indication (in 3gpp-Sbi-Binding) indicating a binding level bl=nf-set and a NF Set ID nfset=set1.xxxset.5gc.mnc012.mcc300. The request further contains, in its message body (e.g., sliceInfo), information on a network slice to which the first NF belongs (referred to as slice information hereinafter, e.g., S-NSSAI). Alternatively, at 9.1b, the NF sends, via the SCP, a subscription request (Namf_Communication_AMFStatusChangeSubscribe Request) to the AMF. The request contains a callback URI (amfStatusUri) and a binding indication (in 3gpp-Sbi-Binding) indicating a binding level bl=nf-set and a NF Set ID nfset=set1.xxxset.5gc.mnc012.mcc300. The request further contains the slice information (e.g., S-NSSAI) in an HTTP custom header (e.g., Slice-Info).

At 9.2, the AMF responds, via the SCP, with a subscription response (Namf_Communication_AMFStatusChangeSubscribe Response). At 9.3, the AMF sends, to an NSSF, a request (Nnssf_NSSelection_Get) for an URI of an NRF associated with the slice information. At 9.4, the NSSF responds with the URI (e.g., nrfDiscUri) in a Nnssf_NSSelection_Get Response. At 9.5, the AMF sends a notification to the SCP. The notification contains the binding indication and the URI (e.g., in 3gpp-Sbi-Nrf-Uri). At 9.6, the SCP detects a failure of the NF or a failure in delivery of a notification to the NF. At 9.7, the SCP sends a discovery request (Nnrf_NFDiscover Request) to the NRF using the URI, with a target NF Set ID set to set1.xxxset.5gc.mnc012.mcc30. At 9.8, the NRF responds with one or more NF profiles of one or more NF instances in the target NF Set. Then, the SCP can select, from the one or more NF instances, an alternative NF and send the notification to the alternative NF.

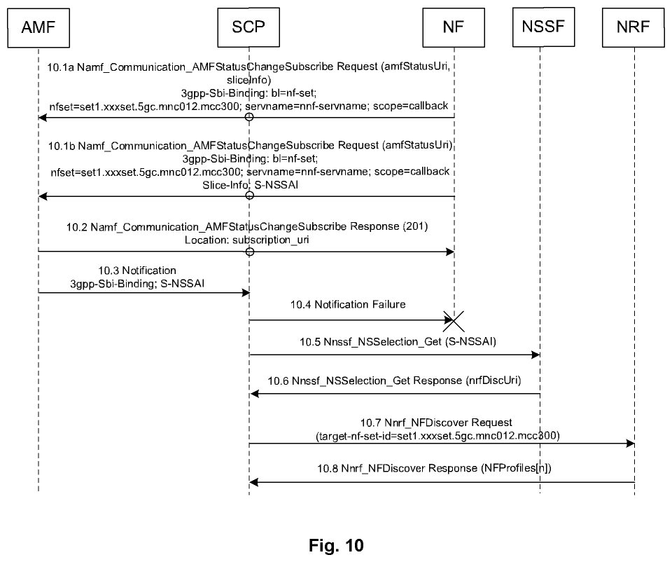

FIG. 10 shows an exemplary procedure of AMF status change notification, with indirect communication via an SCP between the NF and the AMF. As shown, at 10.1a, the NF sends, via the SCP, a subscription request (Namf_Communication_AMFStatusChangeSubscribe Request) to the AMF. The request contains a callback URI (amfStatusUri) and a binding indication (in 3gpp-Sbi-Binding) indicating a binding level bl=nf-set and a NF Set ID nfset=set1.xxxset.5gc.mnc012.mcc300. The request further contains, in its message body (e.g., sliceInfo), information on a network slice to which the first NF belongs (referred to as slice information hereinafter, e.g., S-NSSAI). Alternatively, at 10.1b, the NF sends, via the SCP, a subscription request (Namf_Communication_AMFStatusChangeSubscribe Request) to the AMF. The request contains a callback URI (amfStatusUri) and a binding indication (in 3gpp-Sbi-Binding) indicating a binding level bl=nf-set and a NF Set ID nfset=set1.xxxset.5gc.mnc012.mcc300. The request further contains the slice information (e.g., S-NSSAI) in an HTTP custom header (e.g., Slice-Info).

At 10.2, the AMF responds, via the SCP, with a subscription response (Namf_Communication_AMFStatusChangeSubscribe Response). At 10.3, the AMF sends a notification to the SCP. The notification contains the binding indication and the slice information (e.g., S-NSSAI). At 10.4, the SCP detects a failure of the NF or a failure in delivery of a notification to the NF. At 10.5, the SCP sends, to an NSSF, a request (Nnssf_NSSelection_Get) for an URI of an NRF associated with the slice information. At 10.6, the NSSF responds with the URI (e.g., nrfDiscUri) in a Nnssf_NSSelection_Get Response. At 10.7, the SCP sends a discovery request (Nnrf_NFDiscover Request) to the NRF using the URI, with a target NF Set ID set to set1.xxxset.5gc.mnc012.mcc30. At 10.8, the NRF responds with one or more NF profiles of one or more NF instances in the target NF Set. Then, the SCP can select, from the one or more NF instances, an alternative NF and send the notification to the alternative NF.

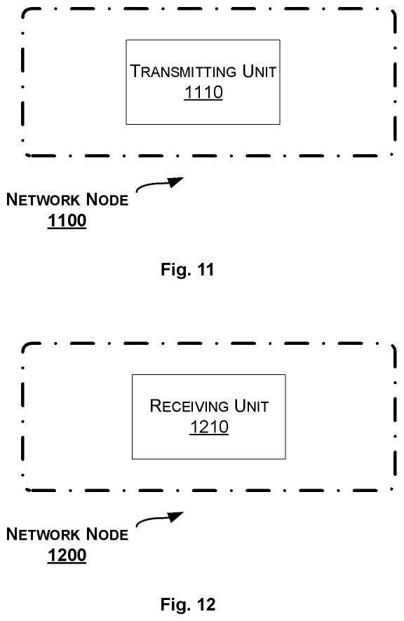

Correspondingly to the method 200 as described above, a network node is provided. FIG. 11 is a block diagram of a network node 1100 according to an embodiment of the present disclosure. The network node 1100 can be configured to implement a first NF.

The network node 1100 is operative to perform the method 200 as described above in connection with FIG. 2. The network node 1100 includes a transmitting unit 1110 configured to transmit, to a second NF, a subscription request for subscribing to a notification from the second NF. The subscription request contains: a URI of an NRF, to be used to discover an alternative NF for the notification, or information on a network slice to which the first NF belongs.

In an embodiment, the URI or the information may be contained in a message body of the subscription request.

In an embodiment, the URI or the information may be contained in an HTTP custom header in the subscription request.

In an embodiment, the URI may be an NRF API URI for an NF discovery service, or the information may be S-NSSAI.

In an embodiment, the subscription request may further contain a binding indication for reselection of the alternative NF.

In an embodiment, each of the first NF and the alternative NF may be an NF consumer and the second NF may be an NF producer.

In an embodiment, the second NF may be an AMF.

The unit 1110 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 2.

Correspondingly to the method 300 or 400 as described above, a network node is provided. FIG. 12 is a block diagram of a network node 1200 according to an embodiment of the present disclosure. The network node 1200 can be configured to implement a second NF.

The network node 1200 may be operative to perform the method 300 as described above in connection with FIG. 3. The network node 1200 may include a receiving unit 1210 configured to receive, from a first NF, a subscription request for subscribing to a notification from the second NF. The subscription request contains a URI of an NRF to be used to discover an alternative NF for the notification.

In an embodiment, the URI may be contained in a message body of the subscription request or in an HTTP custom header in the subscription request.

In an embodiment, the network node 1200 may further include a transmitting unit configured to transmit an NF discovery request for discovering the alternative NF to the NRF using the URI. The receiving unit 1210 may be further configured to receive, from the NRF, an NF profile of the alternative NF. The transmitting unit may be further configured to transmit the notification to the alternative NF.

In an embodiment, the NF discovery request may be transmitted in response to detecting a failure of the first NF or a failure in delivery of the notification to the first NF.

In an embodiment, the subscription request may further contain a binding indication for reselection of the alternative NF, and the NF discovery request may be for discovering the alternative NF based on the binding indication.

In an embodiment, the network node 1200 may further include a transmitting unit configured to transmit the notification to a Service Communication Proxy (SCP) between the first NF and the second NF, the notification containing the URI.

In an embodiment, the URI may be contained in an HTTP custom header in the notification.

In an embodiment, the subscription request may further contain a binding indication for reselection of the alternative NF, and the notification may further contain the binding indication.

In an embodiment, the URI may be an NRF API URI for an NF discovery service.

In an embodiment, each of the first NF and the alternative NF may be an NF consumer and the second NF may be an NF producer.

In an embodiment, the second NF may be an AMF.

Alternatively, the network node 1200 may be operative to perform the method 400 as described above in connection with FIG. 4. The network node 1200 may include a receiving unit 1210 configured to receive, from a first NF, a subscription request for subscribing to a notification from the second NF. The subscription request contains information on a network slice to which the first NF belongs.

In an embodiment, the information may be contained in a message body of the subscription request or in an HTTP custom header in the subscription request.

In an embodiment, the network node 1200 may further include an obtaining unit configured to obtain, from an NSSF, a URI of an NRF associated with the network slice using the information.

In an embodiment, the network node 1200 may further include a transmitting unit configured to transmit an NF discovery request for discovering an alternative NF for the notification to the NRF using the URI. The receiving unit 1210 may be further configured to receive, from the NRF, an NF profile of the alternative NF.

The transmitting unit may be further configured to transmit the notification to the alternative NF.

In an embodiment, the URI may be obtained and/or the NF discovery request may be transmitted in response to detecting a failure of the first NF or a failure in delivery of the notification to the first NF.

In an embodiment, the subscription request may further contain a binding indication for reselection of the alternative NF, and the NF discovery request may be for discovering the alternative NF based on the binding indication.

In an embodiment, the network node 1200 may further include a transmitting unit configured to transmit the notification to an SCP between the first NF and the second NF, the notification containing the URI.

In an embodiment, the URI may be contained in an HTTP custom header in the notification.

In an embodiment, the URI may be an NRF API URI for an NF discovery service.

In an embodiment, the network node 1200 may further include a transmitting unit configured to transmit the notification to an SCP between the first NF and the second NF, the notification containing the information.

In an embodiment, the subscription request may further contain a binding indication for reselection of the alternative NF, and the notification may further contain the binding indication.

In an embodiment, the information may be S-NSSAI.

In an embodiment, each of the first NF and the alternative NF may be an NF consumer and the second NF may be an NF producer.

In an embodiment, the second NF may be an AMF.

The unit 1210 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 3 or 4.

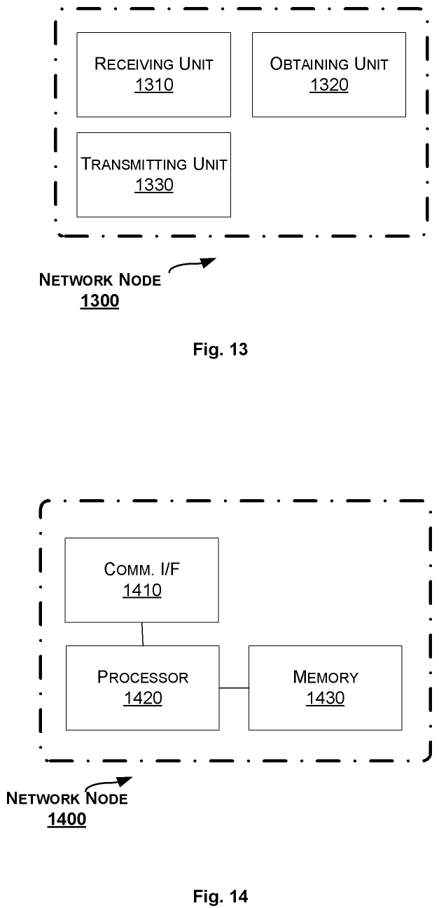

Correspondingly to the method 500 as described above, a network node is provided. FIG. 13 is a block diagram of a network node 1300 according to an embodiment of the present disclosure. The network node 1300 can be configured to implement an SCP between a first NF and a second NF.

The network node 1300 may be operative to perform the method 500 as described above in connection with FIG. 5. The network node 1300 includes a receiving unit 1310 configured to receive, from the second NF, a notification to be forwarded to the first NF. The notification containing information on a network slice to which the first NF belongs. The network node 1300 further includes an obtaining unit 1320 configured to obtain, from an NSSF, a URI of an NRF associated with the network slice using the information. The network node 1300 includes a transmitting unit 1330 configured to transmit an NF discovery request for discovering an alternative NF for the notification to the NRF using the URI. The receiving unit 1310 is further configured to receive, from the NRF, an NF profile of the alternative NF. The transmitting unit 1330 is further configured to transmit the notification to the alternative NF.

In an embodiment, the URI may be obtained and/or the NF discovery request may be transmitted in response to detecting a failure in delivery of the notification to the first NF.

In an embodiment, the notification may further contain a binding indication for reselection of the alternative NF, and the NF discovery request may be for discovering the alternative NF based on the binding indication.

In an embodiment, the information may be S-NSSAI, and/or the URI may be an NRF API URI for an NF discovery service.

In an embodiment, each of the first NF and the alternative NF may be an NF consumer and the second NF may be an NF producer.

In an embodiment, the second NF may be an AMF.

The units 1310˜1330 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 5.

FIG. 14 is a block diagram of a network node 1400 according to another embodiment of the present disclosure.

The network node 1400 includes a communication interface 1410, a processor 1420 and a memory 1430.

The memory 1430 may contain instructions executable by the processor 1420 whereby the network node 1400 is operative to, when implementing a first NF, perform the actions, e.g., of the procedure described earlier in conjunction with FIG. 2. Particularly, the memory 1430 may contain instructions executable by the processor 1420 whereby the network node 1400 is operative to, when implementing a first NF: transmit, to a second NF, a subscription request for subscribing to a notification from the second NF. The subscription request contains: a URI of an NRF, to be used to discover an alternative NF for the notification, or information on a network slice to which the first NF belongs.

In an embodiment, the URI or the information may be contained in a message body of the subscription request.

In an embodiment, the URI or the information may be contained in an HTTP custom header in the subscription request.

In an embodiment, the URI may be an NRF API URI for an NF discovery service, or the information may be S-NSSAI.

In an embodiment, the subscription request may further contain a binding indication for reselection of the alternative NF.

In an embodiment, each of the first NF and the alternative NF may be an NF consumer and the second NF may be an NF producer.

In an embodiment, the second NF may be an AMF.

Alternatively, the memory 1430 may contain instructions executable by the processor 1420 whereby the network node 1400 is operative to, when implementing a second NF, perform the actions, e.g., of the procedure described earlier in conjunction with FIG. 3. Particularly, the memory 1430 may contain instructions executable by the processor 1420 whereby the network node 1400 is operative to, when implementing a second NF: receive, from a first NF, a subscription request for subscribing to a notification from the second NF. The subscription request contains a URI of an NRF to be used to discover an alternative NF for the notification.

In an embodiment, the URI may be contained in a message body of the subscription request or in an HTTP custom header in the subscription request.

In an embodiment, the memory 1430 may further contain instructions executable by the processor 1420 whereby the network node 1400 is operative to, when implementing the second NF: transmit an NF discovery request for discovering the alternative NF to the NRF using the URI; receive, from the NRF, an NF profile of the alternative NF; and transmit the notification to the alternative NF.

In an embodiment, the NF discovery request may be transmitted in response to detecting a failure of the first NF or a failure in delivery of the notification to the first NF.

In an embodiment, the subscription request may further contain a binding indication for reselection of the alternative NF, and the NF discovery request may be for discovering the alternative NF based on the binding indication.

In an embodiment, the memory 1430 may further contain instructions executable by the processor 1420 whereby the network node 1400 is operative to, when implementing the second NF: transmit the notification to an SCP between the first NF and the second NF, the notification containing the URI.

In an embodiment, the URI may be contained in an HTTP custom header in the notification.

In an embodiment, the subscription request may further contain a binding indication for reselection of the alternative NF, and the notification may further contain the binding indication.

In an embodiment, the URI may be an NRF API URI for an NF discovery service.

In an embodiment, each of the first NF and the alternative NF may be an NF consumer and the second NF may be an NF producer.

In an embodiment, the second NF may be an AMF.

Alternatively, the memory 1430 may contain instructions executable by the processor 1420 whereby the network node 1400 is operative to, when implementing a second NF, perform the actions, e.g., of the procedure described earlier in conjunction with FIG. 4. Particularly, the memory 1430 may contain instructions executable by the processor 1420 whereby the network node 1400 is operative to, when implementing a second NF: receive, from a first NF, a subscription request for subscribing to a notification from the second NF. The subscription request contains information on a network slice to which the first NF belongs.

In an embodiment, the information may be contained in a message body of the subscription request or in an HTTP custom header in the subscription request.

In an embodiment, the memory 1430 may further contain instructions executable by the processor 1420 whereby the network node 1400 is operative to, when implementing the second NF: obtain, from an NSSF, a URI of an NRF associated with the network slice using the information.

In an embodiment, the memory 1430 may further contain instructions executable by the processor 1420 whereby the network node 1400 is operative to, when implementing the second NF: transmit an NF discovery request for discovering an alternative NF for the notification to the NRF using the URI; receive, from the NRF, an NF profile of the alternative NF; and transmit the notification to the alternative NF.

In an embodiment, the URI may be obtained and/or the NF discovery request may be transmitted in response to detecting a failure of the first NF or a failure in delivery of the notification to the first NF.

In an embodiment, the subscription request may further contain a binding indication for reselection of the alternative NF, and the NF discovery request may be for discovering the alternative NF based on the binding indication.

In an embodiment, the memory 1430 may further contain instructions executable by the processor 1420 whereby the network node 1400 is operative to, when implementing the second NF: transmit the notification to an SCP between the first NF and the second NF, the notification containing the URI.

In an embodiment, the URI may be contained in an HTTP custom header in the notification.

In an embodiment, the URI may be an NRF API URI for an NF discovery service.

In an embodiment, the memory 1430 may further contain instructions executable by the processor 1420 whereby the network node 1400 is operative to, when implementing the second NF: transmit the notification to an SCP between the first NF and the second NF, the notification containing the information.

In an embodiment, the subscription request may further contain a binding indication for reselection of the alternative NF, and the notification may further contain the binding indication.

In an embodiment, the information may be S-NSSAI.

In an embodiment, each of the first NF and the alternative NF may be an NF consumer and the second NF may be an NF producer.

In an embodiment, the second NF may be an AMF.

Alternatively, the memory 1430 may contain instructions executable by the processor 1420 whereby the network node 1400 is operative to, when implementing an SCP, perform the actions, e.g., of the procedure described earlier in conjunction with FIG. 5. Particularly, the memory 1430 may contain instructions executable by the processor 1420 whereby the network node 1400 is operative to, when implementing an SCP between a first NF and a second NF: receive, from the second NF, a notification to be forwarded to the first NF, the notification containing information on a network slice to which the first NF belongs; obtain, from an NSSF, a URI of an NRF associated with the network slice using the information; transmit an NF discovery request for discovering an alternative NF for the notification to the NRF using the URI; receive, from the NRF, an NF profile of the alternative NF; and transmit the notification to the alternative NF.

In an embodiment, the URI may be obtained and/or the NF discovery request may be transmitted in response to detecting a failure in delivery of the notification to the first NF.

In an embodiment, the notification may further contain a binding indication for reselection of the alternative NF, and the NF discovery request may be for discovering the alternative NF based on the binding indication.

In an embodiment, the information may be S-NSSAI, and/or the URI may be an NRF API URI for an NF discovery service.

In an embodiment, each of the first NF and the alternative NF may be an NF consumer and the second NF may be an NF producer.

In an embodiment, the second NF may be an AMF.

The present disclosure also provides at least one computer program product in the form of a non-volatile or volatile memory, e.g., a non-transitory computer readable storage medium, an Electrically Erasable Programmable Read-Only Memory (EEPROM), a flash memory and a hard drive. The computer program product includes a computer program. The computer program includes: code/computer readable instructions, which when executed by the processor 1420 causes the network node 1400 to perform the actions, e.g., of the procedure described earlier in conjunction with FIG. 2, 3, 4, or 5.

The computer program product may be configured as a computer program code structured in computer program modules. The computer program modules could essentially perform the actions of the flow illustrated in FIG. 2, 3, 4, or 5.

The processor may be a single CPU (Central Processing Unit), but could also comprise two or more processing units. For example, the processor may include general purpose microprocessors; instruction set processors and/or related chips sets and/or special purpose microprocessors such as Application Specific Integrated Circuits (ASICs). The processor may also comprise board memory for caching purposes. The computer program may be carried in a computer program product connected to the processor. The computer program product may comprise a non-transitory computer readable storage medium on which the computer program is stored. For example, the computer program product may be a flash memory, a Random Access Memory (RAM), a Read-Only Memory (ROM), or an EEPROM, and the computer program modules described above could in alternative embodiments be distributed on different computer program products in the form of memories.

The disclosure has been described above with reference to embodiments thereof. It should be understood that various modifications, alternations and additions can be made by those skilled in the art without departing from the spirits and scope of the disclosure. Therefore, the scope of the disclosure is not limited to the above particular embodiments but only defined by the claims as attached.

The present disclosure further provides the following embodiments based on the 3GPP TS 29.500.

### 5.2.3.2.1 General

The 3GPP NF Services shall support the HTTP custom headers specified in Table 5.2.3.2.1-1 below. A description of each custom header and the normative requirements on when to include them are also provided in Table 5.2.3.2-1.

| Name | Reference | Description |
|---|---|---|
| . . . | . . . | . . . |
| 3gpp-Sbi-Nrf-Uri-Callback | Clause 5.2.3.2.x | This header may be used to indicate the NRF API |
| | | URI to be used to discover an alternative NF |
| | | consumer for callback, e.g. during NF consumer |
| | | reselection for callback when the original NF |
| | | consumer is no longer available. |

### 5.2.3.2.x 3gpp-Sbi-Nrf-Uri-Callback

The header contains the NRF API URI for NF discovery service. See clauses 6.5.3.2.
The encoding of the header follows the ABNF as defined in IETF RFC 7230 [12].
3gpp-Sbi-Nrf-Uri-Callback=“3gpp-Sbi-Nrf-Uri-Callback” “:” parameter*(OWS “;” parameter)
parameter =parametername “:” RWS parametervalue
parametername=“nnrf-disc”/token
   NOTE: token is defined for future extensibility.
parametervalue=DQUOTE URI DQUOTE
URI shall comply with the URI definition in IETF RFC 3986 [14].
   EXAMPLE: Header with NRF NF Discovery Service:
      3gpp-Sbi-Nrf-Uri-Callback: nnrf-disc: “https://nrf1.operator.com/nnrf-disc/v1/”

### 6.5.3.2 Stateless NF as service consumer

1. When the NF service consumer subscribes (explicitly or implicitly) to notifications from another NF service producer, the NF service consumer may provide a binding indication to the NF service producer as specified in clause 6.3.1.0 of 3GPP TS 23.501 [3] and clause 4.17.12.4 of 3GPP TS 23.502 [4], to enable the related notifications to be sent to an alternative NF service consumer within the NF (service) set, in addition to providing the Callback URI in the subscription resource. The NF consumer may provide the NRF API URI in 3gpp-Sbi-Nrf-Uri-Callback header which will be used for reselection of NF service consumer.
2. A NF service producer or SCP may use the Nnrf_NFDiscovery service to discover NF service consumers within an NF (service) set. If the NRF API URI was received in the 3gpp-Sbi-Nrf-Uri-Callback header in bullet 1, the NRF API URI shall be used for the reselection.
3. An NF service producer may become aware of a NF service consumer change, via receiving an updated binding information (i.e. when the binding entity corresponding to the binding level is changed) in a HTTP request message, or via an Error response to a notification, via link level failures (e.g. no response from the NF), or via a notification from the NRF that the NF service consumer has deregistered. The HTTP error response may be a 3xx redirect response pointing to a new NF service consumer.
NOTE 1: When the binding entity other than the one corresponding to the binding level is changed. it indicates the resilience information of the session is changed. i.e. more or less consumer instances are able to handle the Notification/Callback request message: the NF service producer is not expected to change Notification/Callback URI.
NOTE 2: When a Binding Indication is included in an acceptance response message, the NF service producer stores the Binding Indication, but does not check it to determine whether there is a NF service consumer change. Accordingly, the NF service producer continues to use its current Notification/Callback URI for subsequent requests, until it becomes aware of an NF service consumer change, at which point in time it uses the last received binding information to reselect a different instance.
4. When becoming aware of an NF service consumer change, and if the new NF service consumer is not known, the NF service producer shall select a new NF service consumer as specified in clause 6.6 of 3GPP TS 23.527 [38]. If binding information is available and the binding mechanism is supported by the NF service producer, the reselection should be based on the binding information, as specified in clause 6.6.2 of 3GPP TS 23.527 [38], in clause 6.3.1.0 of 3GPP TS 23.501 [3] and in clause 4.17.12.4 of 3GPP TS 23.502 [4]. If binding information is not available or the binding mechanism is not supported by the NF service producer, the reselection is performed as specified in clause 6.6.3 of 3GPP TS 23.527 [38].
5. When becoming aware of an NF service consumer change, the NF service producer or SCP shall replace the authority part of the Notification/Callback URI with the new NF service consumer information and shall use that URI in subsequent communications, as specified in clause 6.6 of 3GPP TS 23.527 [38].
6. When the NF service consumer is changed, and if the new NF service consumer does not support handling notifications as specified in the above bullet 5, the new NF service consumer should update the NF service producers with the new Notification URI. For explicit subscriptions, this is achieved by updating the existing subscription or creating a new subscription, depending on the NF service producer's API. For implicit subscriptions, this is carried out via a service update request message.

7. The new NF service consumer may include an updated binding indication in a service request or notification response message to the NF service producer.
8. Each NF service consumer within the NF (service) set shall be prepared to receive notifications from the NF service producer, either by handling the notifications to the Notification URI constructed according to the above bullet 5 with its own address as authority part, by handling the notifications to the Notification URI notified in the above bullet 6, or by replying with an HTTP 3xx redirect pointing to a new NF service consumer or with another HTTP error.
9. The NF service producer shall be prepared to receive updates to resources of the related service from any NF service consumer within the NF (service) set.
10. If an SCP detects that the target NF service consumer of a notification/callback request is not available, the SCP may select a new NF service consumer based on either Routing Binding Indication, if available and supported by the SCP, or by relying on 3gpp-Sbi-Discovery headers, if provided by the NF service producer. See clause 6.6 in 3GPP TS 23.527 [38].

### 6.10.7 Notification and callback requests sent with Indirect Communication

Notification and callback requests that are sent using indirect communication shall include a 3gpp-Sbi-Callback header including the name of the notification or callback service operation (see Annex B) and the API major version if higher than 1.
The SCP may derive from the presence of this header that a service request is a notification or callback request.
   NOTE: This can be used by the SCP to apply differentiated treatments for notification and callback requests compared to other service requests, e.g. for authorization (access token is not used in notification/callback, see clause 6.7.3).
The NF producer shall include the NRF API URI for NF consumer reslection in 3gpp-Sbi-Nrf-Uri header, if previously received from the NF consumer in 3gpp-Sbi-Nrf-Uri-Callback header (see clause 6.5.3.2). The SCP shall use the NRF API URI to discover alternative NF consumer when reselection is needed.

1. A method in a first Network Function, NF, comprising:
transmitting, to a second NF, a subscription request for subscribing to a notification from the second NF, the subscription request containing:
a Uniform Resource Identifier, URI, of an NF Repository Function, NRF, to be used to discover an alternative NF for the notification for callback when the original NF is no longer available.

2. (canceled)

3. The method of claim 1, wherein the URI is contained in a HyperText Transfer Protocol, HTTP, custom header in the subscription request.

4. The method of claim 1, wherein the subscription request further contains a binding indication for reselection of the alternative NF.

5. The method of claim 1, wherein each of the first NF and the alternative NF is an NF consumer and the second NF is an NF producer.

6. (canceled)

7. A method in a second Network Function, NF, comprising:
receiving, from a first NF, a subscription request for subscribing to a notification from the second NF, the subscription request containing a Uniform Resource Identifier, URI, of an NF Repository Function, NRF, to be used to discover an alternative NF for the notification for callback when the original NF is no longer available.

8. The method of claim 7, wherein the URI is contained in a HyperText Transfer Protocol, HTTP, custom header in the subscription request.

9. The method of claim 7, further comprising:
transmitting an NF discovery request for discovering the alternative NF to the NRF using the URI;
receiving, from the NRF, an NF profile of the alternative NF; and
transmitting the notification to the alternative NF.

10. The method of claim 9, wherein the NF discovery request is transmitted in response to detecting a failure of the first NF or a failure in delivery of the notification to the first NF.

11. The method of claim 9, wherein the subscription request further contains a binding indication for reselection of the alternative NF, and the NF discovery request is for discovering the alternative NF based on the binding indication.

12. The method of claim 7, further comprising:
transmitting the notification to a Service Communication Proxy, SCP, between the first NF and the second NF, the notification containing the URI.

13. The method of claim 12, wherein the URI is contained in a HyperText Transfer Protocol, HTTP, custom header in the notification.

14. The method of claim 12, wherein the subscription request further contains a binding indication for reselection of the alternative NF, and the notification further contains the binding indication.

15. The method of claim 7, wherein the URI is an NRF Application Programming Interface, API, URI for an NF discovery service.

16. The method of claim 7, wherein each of the first NF and the alternative NF is an NF consumer and the second NF is an NF producer.

17. (canceled)

18. A method in a Service Communication Proxy, SCP, between a first Network Function, NF, and a second NF, the method comprising:
receiving, from the second NF, a notification to be forwarded to the first NF, the notification containing information on a network slice to which the first NF belongs;
obtaining, from a Network Slice Selection Function, NSSF, a Uniform Resource Identifier, URI, of an NF Repository Function, NRF, associated with the network slice using the information;
transmitting, to the NRF by using the URI, an NF discovery request for discovering an alternative NF for the notification;
receiving, from the NRF, an NF profile of the alternative NF; and
transmitting the notification to the alternative NF.

19. The method of claim 18, wherein the URI is obtained and/or the NF discovery request is transmitted in response to detecting a failure in delivery of the notification to the first NF.

20. The method of claim 18, wherein the notification further contains a binding indication for reselection of the alternative NF, and the NF discovery request is for discovering the alternative NF based on the binding indication.

21. The method of claim 18, wherein the information is Single Network Slice Selection Assistance Information, S-NSSAI, and/or the URI is an NRF Application Programming Interface, API, URI for an NF discovery service.

22. The method of claim 18, wherein each of the first NF and the alternative NF is an NF consumer and the second NF is an NF producer.

23. (canceled)

24. (canceled)

25. (canceled)

26. A first Network Function, NF, comprising:
a communication interface,
a processor, and
a memory having instructions that, when executed by the processor, configure the first NF to transmit, to a second NF, a subscription request for subscribing to a notification from the second NF, the subscription request containing:
a Uniform Resource Identifier, URI, of an NF Repository Function, NRF, to be used to discover an alternative NF for the notification for callback when the original NF is no longer available.

27. The first NF of claim 26, wherein:
the URI is contained in a HyperText Transfer Protocol, HTTP, custom header in the subscription request;
the subscription request further contains a binding indication for reselection of the alternative NF; and
each of the first NF and the alternative NF is an NF consumer and the second NF is an NF producer.

28. A second Network Function, NF, comprising:
a communication interface,
a processor, and
a memory having instructions that, when executed by the processor, configure the second NF to receive, from a first NF, a subscription request for subscribing to a notification from the second NF, the subscription request containing a Uniform Resource Identifier, URI, of an NF Repository Function, NRF, to be used to discover an alternative NF for the notification for callback when the original NF is no longer available.

29. The second NF of claim 28, wherein the URI is contained in a HyperText Transfer Protocol, HTTP, custom header in the subscription request.

30. The second NF of claim 28, wherein the instructions, when executed by the processor, configure the second NF to:
transmit an NF discovery request for discovering the alternative NF to the NRF using the URI;
receive, from the NRF, an NF profile of the alternative NF; and
transmit the notification to the alternative NF.

31. The second NF of claim 30, wherein the NF discovery request is transmitted in response to detecting a failure of the first NF or a failure in delivery of the notification to the first NF.
